(19) United States
(12) Patent Application Publication
(10) Pub. No.: US 2002/0046634 A1
(43) Pub. Date: Apr. 25, 2002

(54) Device and method for dividing strip-like or tape-like media in assembly machines

(75) Inventors: Manfred Schlatter, Freiburg (DE); Manfred Kraus, Kehl (DE); Richard Scheidecker, Rheinau (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 09/981,808

(22) Filed: Oct. 19, 2001

(30) Foreign Application Priority Data
Oct. 20, 2000 (DE) 200 17 965.9

(51) Int. Cl. B26D 7/06

(52) U.S. Cl. 83/111; 83/78

(57) ABSTRACT

Device and method for dividing media in assembly machines, comprising a pneumatic linear guide unit with fitted stroke limiting units, the media being movable on a support in a first direction. A carriage has a linear movement in a direction which runs transversely with respect to the first direction. A holder is attached to the carriage and a knife is attached to the holder by way of a rotatable shaft. Constructional elements convert linear movement of the carriage into a rotational movement of the knife, wherein the knife cuts transversely through the media while the tape is firmly held on the support.

### CROSS-REFERENCE TO RELATED APPLICATIONS

The present application claims priority under 35 U.S.C. § 119 of German Patent Application No. 200 17 965.9, filed Oct. 20, 2000, the disclosure of which is expressly incorporated by reference herein in its entirety.

### BACKGROUND OF THE INVENTION

1. Field of the Invention

The invention relates to a device for dividing strip-like or tape-like media in assembly machines, preferably magnetic tape in automatic spooling machines.

2. Description of Related Art

Strip-like or tape-like media are generally produced in a greater width than the width of the end product, for economic reasons, in particular when they are provided with a functional layer. Media provided with a functional layer are understood, for example, to be adhesive tapes, capacitor films and, in particular, tape-like magnetic recording media. Following the coating of the substrate material with the functional layer, there follows the division to usable width in cutting or dividing machines and, then, winding up onto winding cores or spools. The raw coil is produced in this manner as a tape length of several thousand meters and, if the tape-like medium is a magnetic recording medium, is referred to as a pancake and constitutes the intermediate product for the final processing of the medium to form the recorded or else unrecorded cassette.

### SUMMARY OF THE INVENTION

Spooling the magnetic tape into cassettes is preferably done on automatic spooling machines, as they are known, also referred to in the technical field as loaders.

The loaders operate substantially more economically than the prior art winders. The use of loaders presupposes the use of pre-equipped cassettes, as they are known. In the case of the earlier winder techniques, the tape units to be processed further comprised a spool wound with magnetic tape and an empty spool, the two spools being connected to one another via the pre-tensioning tape fitted to the ends of the magnetic tape. This unit, together with the entire individual parts of the cassettes, had to be assembled together, a finished, assembled cassette being inserted into the loader. In addition to the two empty spools, this pre-equipped cassette also already contains the pretensioning tape, as it is called, the ends of the latter being fixed to the spools. The pretensioning tape itself comprises a strip of transparent film, similar to the magnetic tape substrate film, the width of the pretensioning tape corresponding to the width of the magnetic tape to be wound onto a spool. The total length of the pretensioning tape corresponds to the sum of the length of the pretensioning tape at the start and at the end of the tape on a cassette.

Before the magnetic tape is wound onto a spool, the pretensioning tape is gripped from the cassette by a mechanism belonging to the loader and is drawn out of the cassette. This mechanism of the loader is approximately similar to the mechanism in a video recorder, which likewise has to thread the magnetic tape for recording or replaying information out of the cassette. After the pretensioning tape has been drawn out of the cassette, the pretensioning tape is firmly held by a suction table, whose surface has holes to which vacuum is applied and is cut through centrally on the suction table, transversely with respect to the actual tape running direction. The start of the magnetic tape to be wound onto a spool is then connected to a now free end of the pretensioning tape by way of a short piece of adhesive tape, to be specific on the side of the cassette which is intended to contain the full spool.

Then, the desired length of the tape is unwound from the previously mentioned pancake and spooled into the cassette, that is to say wound into one spool in the cassette.

After the predefined tape length has been spooled into the cassette, the magnetic tape coming from the pancake is fixed on the suction table, is cut off and the end of the magnetic tape wound onto the spool is again connected to the other end of the previously severed pretensioning tape by way of a short piece of adhesive tape. The now free start of the magnetic tape reel is firmly held by a suction table, using vacuum, and is therefore ready for the next spooling operation.

The quality of the connections between the pretensioning tape and the magnetic tape, which also have an influence on the fault-free behavior of the magnetic tape cassette during subsequent use, depends, inter alia, on the quality of the cut through the magnetic tape. A cut which is not clean can mean an accumulation of particles from the cut edge, and these particles can be distributed on the magnetic tape surface during the use of the cassette and can cause dropouts, as they are called. Dropouts are short outages in the transmission of information during writing or reading, that is to say, during the data transfer between magnetic head and tape, caused by brief enlargement of the distance between the tape and head, depending on the size of the particle.

All the conventional loaders have one or more cutting devices, which either cut through the magnetic tape, the adhesive tape or the pretensioning tape, or which simultaneously fulfil one or more of these functions. A separate cutting device is expediently used for the adhesive tape, in order to prevent adhesive residues from the adhesive tape being deposited on the knife and, during the cutting of the magnetic tape, being deposited on the latter again. As a result, particles generated from the environment or as a result of movement of the spooling device could be retained at the adhesive point, could be distributed over the length of the tape as it is wound and in this way again produce dropouts. Normally, however, it is possible and, because of the physical proximity of the cutting point in the loader, expedient, to cut through both the pretensioning tape and the magnetic tape with the same cutting device.

In the case of conventional loaders, cutting devices based on three different principles are generally integrated, such as those also used to some extent for cutting off the tapes in magnetic tape cutting machines when the tape to be cut off has reached its preselected length.

The magnetic tape can be divided by two cutters which are to be moved parallel toward each other at right angles to the upper side and underside of the magnetic tape and cut through the magnetic tape in a manner similar to a punch.

In addition, systems are known which operate with a sharp cutter, for example with a razor blade. In the case of these systems, the blade is fitted with an inclination between about 10° and 90° to the magnetic tape surface, and the cutter is moved through the magnetic tape transversely to the magnetic tape in order to divide the latter.

A third known system operates with a small pair of shears operated by compressed air or electricity which, in the opened state, are moved over the magnetic tape from the side until the two cutters cover the entire width of the magnetic tape. The cutters of the shears are then closed, that is to say moved toward each other and past each other, the magnetic tape being cut through.

All the previously described systems have the disadvantage that they occasionally or even frequently deliver a poor cut quality, which is induced by the system for constructional reasons. Two punch-like cutters only produce a good quality when the width of the cutting gap, that is to say the distance between the two cutters measured at right angles to their direction of movement and longitudinally with respect to the tape to be cut, is in the range of a few tenths of the tape thickness. Given the low thicknesses of magnetic tape which are usual nowadays, of less than about 20 μm, this would mean that a cutting gap of less than about 2 μm would have to be set reproducibly, which would entail a very great deal of effort and would make the method uneconomical.

Razor blades moving toward the tape surface and transversely with respect to the tape have the disadvantage that they attempt to push the tape away laterally, and this effect is greater, the more blunt the blade has become, as a result of use. This produces a cut which is not clean, not straight and afflicted with particles or even creases, which reduces the quality of the cassette to be produced considerably. Such systems require a considerable expenditure on monitoring and maintenance.

For small shears, the drawbacks mentioned above apply in the same way as for razor blades, except that the forces acting laterally on the magnetic tape to be cut are lower, since the main movement of the shears is carried out virtually at right angles to the surface of the magnetic tape.

A further disadvantage of all the above-described systems is the fact that the magnetic tape is always divided with the same areas as the blade or the cutter. As a result of the hard and abrasive supporting pigments which are contained in the magnetic tapes, such as aluminum oxide, the used cutters quickly become blunt and deliver a poor cut quality or have to be replaced very frequently.

There was therefore the object of producing the cut which, before or after the magnetic tape is wound on to a spool, divides the latter at the desired length, with the best possible quality, that is to say without the production of particles by the cut itself as a result of inadequate cutting technology. In all the systems, attention must be paid to the same extent to the necessary sharpness of the knife. This applies both to the conventional systems and to the knife belonging to the present invention.

The object is achieved with a device for dividing strip-like or tape-like media in assembly machines, preferably magnetic tape in automatic spooling machines, substantially comprising a pneumatic linear guide unit (12) with fitted stroke limiting units, on the carriage (11), whose direction of linear movement runs transversely with respect to the direction of movement (V) of the magnetic tape (20), there being fitted a holder (7) at one end of which a round knife (2) is clamped by way of a clamping ring (5) on a shaft (3) that is rotatably mounted via the rolling-contact bearings (6, 6′), and the linear movement of the carriage (11) being converted by constructional elements into a rotational movement of the round knife (2).

According to the invention, a device for dividing media in assembly machines comprises a pneumatic linear guide unit with fitted stroke limiting units, the media being movable on a support in a first direction, a carriage, having a linear movement in a direction which runs transversely with respect to the first direction and a holder attached to the carriage. A knife is attached to the holder by way of a rotatable shaft and constructional elements are provided for converting linear movement of the carriage into a rotational movement of the knife, wherein the knife cuts transversely through the media while the tape is firmly held on the support.

The media may comprise one of a strip-like or tape-like media. The tape-like media may comprise magnetic tape for use in automatic spooling machines. The knife may comprise a round knife. The knife may be attached at one end of the holder. The knife may be attached to the shaft by way of a force-fitting joint. The shaft may be rotatably mounted via rolling-contact bearings. The support may comprise a suction table. A groove may be formed on a side of the suction table facing the round knife to define a free space, the round knife cutting into the free space.

The constructional elements may comprise a cord, a groove formed in the shaft, and a spring system, the cord being wrapped in the groove around the shaft. Alternatively, the constructional elements may comprise a freewheel including an outer ring, a circumferential groove formed on the ring, and a cord wrapped around the ring in the circumferential groove.

According to an aspect of the invention, the rolling-contact bearings are adjustable virtually without play.

According to yet another aspect of the invention, a device for dividing media in assembly machines comprises a pneumatic linear guide unit with fitted stroke limiting units, the media being movable on a suction table in a first direction. A carriage has a linear movement in a direction which runs transversely with respect to the first direction. A holder is attached to the carriage and a round knife is attached to one end of the holder by way of a force-fitting joint connection to a rotatable shaft, the shaft being rotatably mounted via rolling-contact bearings. Constructional elements convert linear movement of the carriage into a rotational movement of the knife, wherein the round knife cuts transversely through the media while the tape is firmly held on the suction table. A groove is formed on a side of the suction table facing the round knife to define a free space, wherein the round knife cuts into the free space.

Moreover, the invention contemplates a method for dividing media in assembly machines, comprising moving the media on a support in a first direction by way of a pneumatic linear guide unit fitted with stroke limiting units, moving a carriage in a linear direction which runs transversely with respect to the first direction, attaching a holder to the carriage, attaching a knife to the holder by way of a rotatable shaft, and converting linear movement of the carriage into a rotational movement of the knife, wherein the knife cuts transversely through the media while the tape is firmly held on the support.

The attaching of the knife to the shaft may be by force-fitting. A groove may be formed on a side of the suction table facing the round knife, the knife cutting into a free space defined by the groove. A cord may be wrapped around a groove in the shaft. Alternatively, the cord may be wrapped around a circumferential groove formed in a ring of a freewheel. The rolling-contact bearings for the shaft may be adjusted virtually without play.

### BRIEF DESCRIPTION OF THE DRAWINGS

The invention will now be described in more detail using the drawings, in which:

FIG. 1 shows a schematic plan view of a first embodiment of the device;

FIG. 2 shows a schematic side view of a first embodiment of the device;

FIG. 3 shows a section A-B through a first embodiment of the device according to FIG. 1; and

FIG. 4 shows a section A-B similar to FIG. 3 through a second embodiment of the device.

### DETAILED DESCRIPTION OF THE PREFERRED EMBODIMENTS

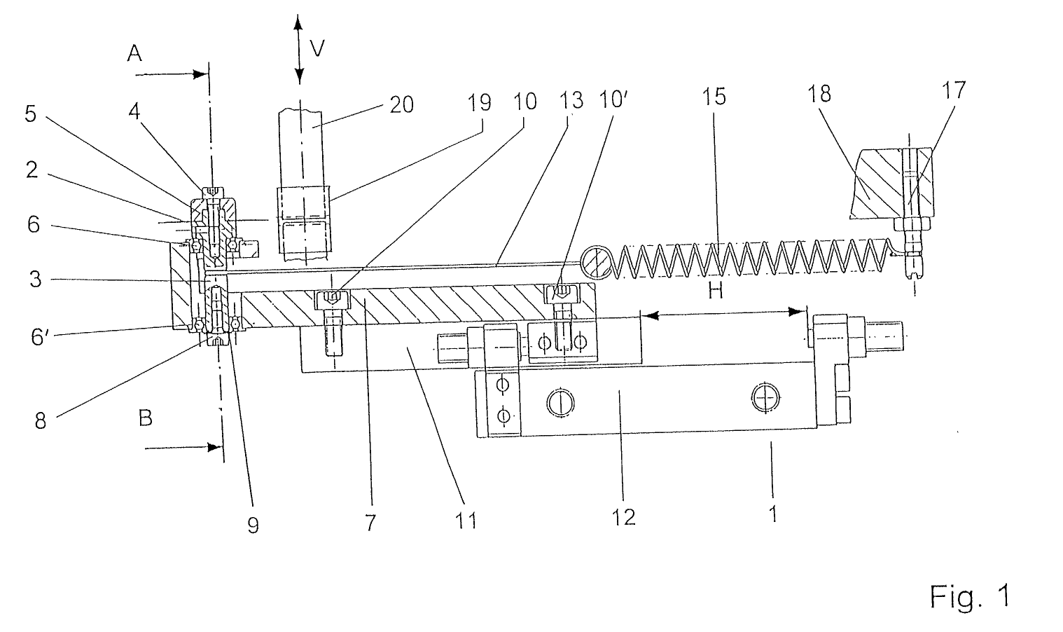

FIG. 1 shows a schematic plan view of a first device (1) according to the invention in the extended state of the carriage (11), the direction of movement (V) of the magnetic tape (20) running vertically from top to bottom or vice versa in this view, and the magnetic tape (20) being shown as already divided.

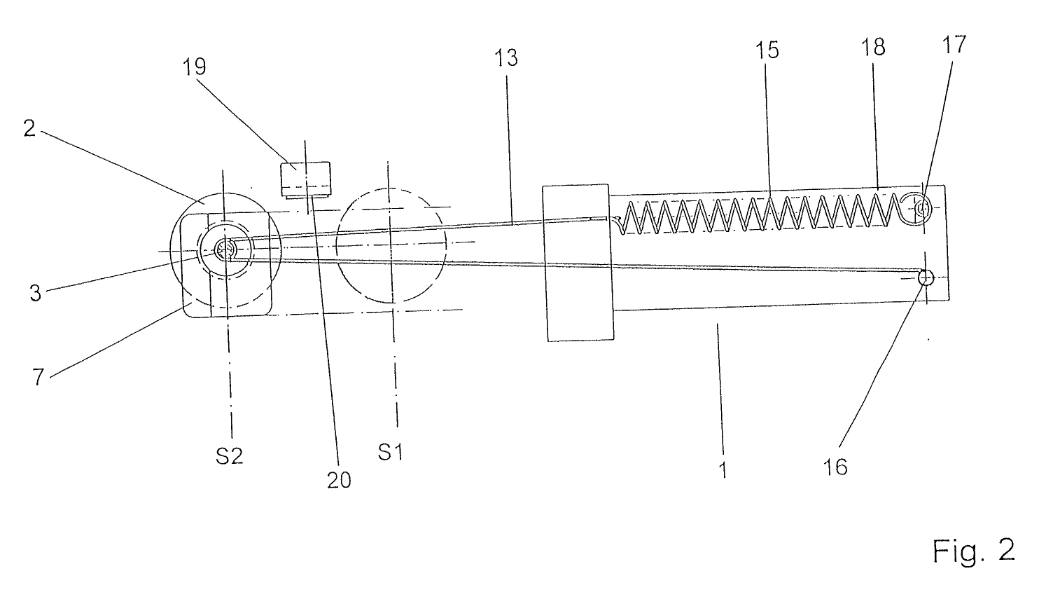

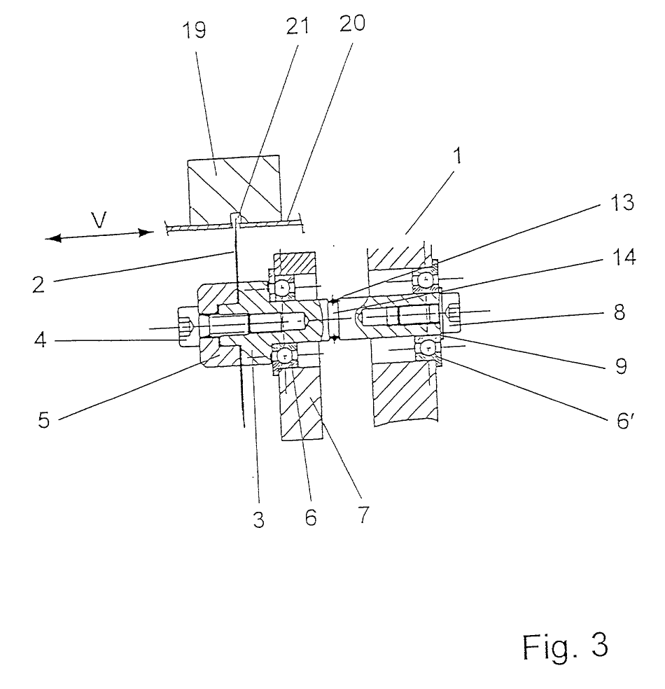

As further revealed in FIG. 1 and FIG. 3, the first embodiment of the device (1) according to the invention substantially comprises a round knife (2), which is fixed to a shaft (3) by way of a clamping ring (5) and a screw (4), the dimensions of shaft (3) and clamping ring (5) being selected such that the screw (4) screwed into the shaft (3) presses on the clamping ring (5) and the latter presses onto the round knife (2) in such a way that the round knife (2) is fixed on the shaft (3) by way of a force-fitting joint. The shaft (3) is rotatably mounted by way of two rolling-contact bearings (6, 6′) in the accommodation holes in the holder (7), the bearings (6, 6′) being adjustable virtually without play by way of the screw (8) and a fitting washer (9), but the shaft 3 still remaining slightly rotatable. The holder (7) is fixed by two screws (10, 10′) to the carriage (11) of a pneumatic linear guide unit (12), which moves the round knife (2) from position (S1) into position (S2), as shown in FIG. 2. Position (S1) designates the rest position of the round knife (2) before the cut, and position (S2) designates the end position of the round knife (2) after the cut, the distance covered here being the stroke (H). Instead of the pneumatic linear guide unit (12), for example a pneumatically operated cylinder or any other component producing a linear movement can also be used.

FIG. 2 shows the schematic side view of the first embodiment of the device in the extended state (position S2) of the round knife (2) after the cut. The position (S1) drawn dashed shows the rest position of the round knife (2) while the magnetic tape (20) is being wound onto the spool in the cassette. The direction of movement (V) of the magnetic tape (20) during spooling is in this case at right angles to the plane of the drawing. In order to make the course of the cord clearly detectable, in this view, the representation of the pneumatic linear guide unit (12) has been omitted, and the holder (7) is only partially shown.

FIG. 3 shows a section A-B through a first embodiment of the device according to FIG. 1. The direction of movement (V) of the magnetic tape (20) during spooling is in this case from right to left or vice versa. The magnetic tape (20) runs in this case over a suction table (19) having a groove (21), which is positioned such that the round knife (2) passes through the latter during the cutting operation.

In accordance with the illustrations in FIG. 1. to FIG. 3, the rotational movement of the round knife (2) is produced by constructional elements which include a cord/spring system, a cord (13) wrapping around the shaft (3) in a circumferential groove (14), and one end of the cord (13) being fixed to the front plate of the loader housing by way of a pin (16) on a mounting plate (18), and the other end of the cord being connected to one end of the tension spring (15), and its other end in turn being fixed to the mounting plate (18) by way of a pin (17), so that, as a result, the movement of the carriage (11), running transversely with respect to the magnetic tape (20), is converted into a rotational movement of the round knife. In accordance with the illustrated embodiment of the device, in this case wrap angles of the cord (13) on the shaft (3) of preferably about 180° or about 360° are possible.

The dimensions of the spring (15) and the cord (13) are selected such that, in the position (S1) of the round knife (2), the spring (15) is prestressed to such an extent that the cord (13) rests tautly in the groove (14) in the shaft (3). If, then, the pneumatic linear guide unit (12) has pressure applied to it, the carriage (11) moves out and the round knife is moved from position (S1) into position (S2), the spring (15) being additionally stressed by the length of the stroke (H), the round knife (2) being set rotating in the counter clockwise direction, because of the deflection geometry of the cord (13), and in this way the magnetic tape (20) being divided as the round knife (2) passes through the suction table (19) provided with a groove (21). As opposed to the previously known systems, during the cut, the round knife does not rest on a cutting edge or a rotating opposing blade, but cuts into the clearance formed by the groove (21), so that a clean cut is produced. The free end of the magnetic tape (20) on the pancake side remains fixed on the suction table (19) and is available for the next spooling operation, while the other end of the magnetic tape (20) is connected by way of an adhesive strip to the free end of the pretensioning tape (not shown).

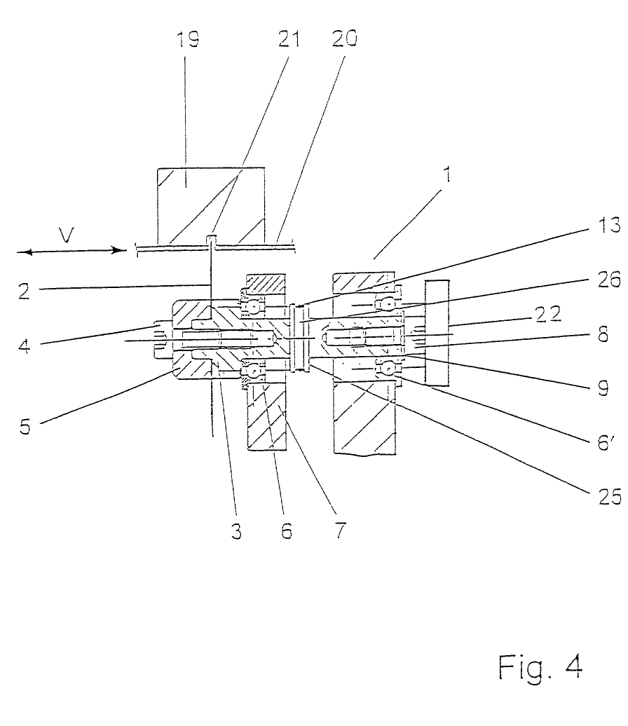

A second preferred embodiment of the device according to the invention as shown in FIG. 4, resides in the constructional elements additionally including a freewheel 22, which is fitted between the rolling-contact bearings (6, 6′), in the area of the circumferential groove (14) previously described. In this case, the cord (13) no longer wraps directly around the shaft (3) but around the additional ring (25) fitted to the outer ring of the freewheel 22 and provided with a circumferential groove (26). This arrangement means that, during the pull-back movement of the carriage (11) into the position (S2), no rotation of the cutting knife (2) in the direction opposite to the rotation during the cutting operation takes place, and, consequently, each cutting operation begins with a different point on the circumference of the cutting knife (2), and therefore the cutting knife (2) wears completely uniformly.

The devices described above are suitable both for the common division of magnetic tape (20) and pretensioning tape (not shown), as described in the introduction, and for separate dividing of only the magnetic tape (20). Obviously, the application of the device is not restricted to the processing of magnetic tapes, but is also advantageously useful in preparing other strip-like or tape-like media.

We claim:

1. A device for dividing media in assembly machines, comprising:
a pneumatic linear guide unit with fitted stroke limiting units, the media being movable on a support in a first direction;
a carriage, having a linear movement in a direction which runs transversely with respect to said first direction;
a holder attached to the carriage;
a knife attached to said holder by way of a rotatable shaft; and
constructional elements for converting linear movement of the carriage into a rotational movement of the knife, wherein the knife cuts transversely through the media while the tape is firmly held on said support.

2. The device of claim 1, wherein the media comprises one of a strip-like or tape-like media.

3. The device of claim 2, wherein said tape-like media comprises magnetic tape for use in automatic spooling machines.

4. The device of claim 1, wherein said knife comprises a round knife.

5. The device of claim 4, wherein said support comprises a suction table.

6. The device of claim 5, further comprising a groove formed on a side of the suction table facing the round knife and defining a free space and wherein said round knife cuts into the free space.

7. The device of claim 1, wherein said knife is attached at one end of said holder.

8. The device of claim 7, wherein said knife is attached to said shaft by way of a force-fitting joint.

9. The device of claim 8, wherein said shaft is rotatably mounted via rolling-contact bearings.

10. The device of claim 9, wherein the rolling-contact bearings are adjustable virtually without play.

11. The device of claim 1, wherein the constructional elements comprise:
a cord;
a groove formed in said shaft; and
a spring system,
wherein the cord is wrapped in said groove around said shaft.

12. The device of claim 1, wherein the constructional elements comprise:
a freewheel including an outer ring;
a circumferential groove formed on said ring; and
a cord wrapped around the ring in said circumferential groove.

13. A device for dividing media in assembly machines, comprising:
a pneumatic linear guide unit with fitted stroke limiting units, the media being movable on a suction table in a first direction;
a carriage, having a linear movement in a direction which runs transversely with respect to said first direction;
a holder attached to the carriage;
a round knife attached to one end of said holder by way of a force-fitting joint connection to a rotatable shaft, said shaft being rotatably mounted via rolling-contact bearings;
constructional elements for converting linear movement of the carriage into a rotational movement of the knife, wherein the round knife cuts transversely through the media while the tape is firmly held on said suction table; and
a groove formed on a side of the suction table facing the round knife and defining a free space, wherein said round knife cuts into the free space.

14. The device of claim 13, wherein the media comprises one of a strip-like or tape-like media.

15. The device of claim 14, wherein said tape-like media comprises magnetic tape for use in automatic spooling machines.

16. The device of claim 13, wherein the constructional elements comprise:
a cord;
a groove formed in said shaft; and
a spring system,
wherein the cord is wrapped in said groove around said shaft.

17. The device of claim 13, wherein the constructional elements comprise:
a freewheel including an outer ring;
a circumferential groove formed on said ring; and
a cord wrapped around the ring in said circumferential groove.

18. A method for dividing media in assembly machines, comprising:
moving the media on a support in a first direction by way of a pneumatic linear guide unit fitted with stroke limiting units;
moving a carriage in a linear direction which runs transversely with respect to said first direction;
attaching a holder to the carriage;
attaching a knife to said holder by way of a rotatable shaft; and
converting linear movement of the carriage into a rotational movement of the knife, wherein the knife cuts transversely through the media while the tape is firmly held on said support.

19. The method of claim 18, wherein said attaching of the knife to said shaft is by force-fitting.

20. The method of claim 18, further comprising forming a groove on a side of the suction table facing the round knife and cutting into a free space defined by the groove.

21. The method of claim 18, further comprising wrapping a cord around a groove in said shaft.

22. The method of claim 18, further comprising wrapping a cord around a circumferential groove formed in a ring of a freewheel.

23. The method of claim 18, further comprising adjusting virtually without play, rolling-contact bearings for the shaft.
